(19) United States
(12) Patent Application Publication
(10) Pub. No.: US 2014/0352575 A1
(43) Pub. Date: Dec. 4, 2014

(54) UV Curing Glue for Glass Substrate and Method for Making the Same

(71) Applicant: Shenzhen China Star Optoelectronics Technology Co., Ltd., Shenzhen (CN)

(72) Inventor: Yawei Liu, Shenzhen (CN)

(21) Appl. No.: 13/984,290

(22) PCT Filed: Jun. 28, 2013
(86) PCT No.: PCT/CN2013/078429

§ 371 Date: Aug. 8, 2013

(30) Foreign Application Priority Data
Jun. 3, 2013 (CN) 201310216058.5

(51) Int. Cl. C09J 11/04

(52) U.S. Cl. CPC C09J 11/04
USPC 106/287.34

(57) ABSTRACT

The present invention provides an ultraviolet curing glue used for sealing glass substrate, comprising ultraviolet glue base (30), and inorganic solid particulates (20) having diameter ranging from 0.1 to 0.3 micro meter and evenly mixed with the ultraviolet glue base (30) to form the ultraviolet curing glue mixture (10), wherein the inorganic solid particulates (20) is less than 40% of the volume of mixture of the curing glue (10). The ultraviolet curing glue made in accordance with the present invention can readily reduce and slow down the moisture permeability rate thereby increasing the moisture blockage of the sealant and prolong the service life of the product. In addition, the method for making the ultraviolet curing glue is comparably simplified, and easy to manipulate.

### FIELD OF THE INVENTION

The present invention relates to packaging of glass substrate, and more particularly, to an ultraviolet curing glue for glass substrate, and also a method for making the same.

### DESCRIPTION OF PRIOR ART

In the technical field of displaying, flat panel display, such as liquid crystal display, organic light emitting diodes has replaced the CRT (cathode ray tube) gradually. Planar light source is a novel light source, and the technology developed thereof has reached to a level for mass production. During the flat panel display and the planar light source, laminating two glass substrates is a very important technology. The sealing of those two glass substrates has a direct influence to the performance of the flat display panel made therefrom.

Curing glue with ultraviolet light is a commonly available technology used in the manufacturing of the LCD/ OLED, and it is featured with the followings. Firstly, no need of solvent or very few amount are needed. Accordingly, contamination to environment is comparably low. Low energy consumption. The curing with ultraviolet light can be conducted under low temperature, and this is specially suitable for heat-sensitive material. Third, fast curing speed, high efficiency, and this can be applied in the high-speed mass production. In addition, the equipment is compact and only limited area is needed. However, since the ultraviolet glue, also known as transparent glue, photosensitive glue, or ultraviolet curable glue, is a kind of glue which has to be cured after irradiation of the ultraviolet light. It can also be used as a bonding agent. The ultraviolet glue is an organic material, and the space between molecules is comparably large. As a result, moisture and oxygen can readily penetrate into the sealed area through the medium, such as shown in FIG. 1. Accordingly, this kind of glue is only suitable for the area in which the material is less sensitive to the moisture (H2O) and oxygen (O2), such as the LCD. Since the OLED is more sensitive to moisture and oxygen, accordingly, when it is sealed with ultraviolet glue, desiccant is necessary to be placed inside the product so as to reduce the damage from the moisture transferred thereto through medium, and thereby prolonging the service life of the OLED product.

Currently, one main research direction to the ultraviolet glue used in the OLED is to find a kind of ultraviolet glue with lower moisture permeability. That is to find a kind of ultraviolet glue that has an even smaller and compact space between molecules after it is cured. Accordingly, once the ultraviolet glue is cured, the channel (space between the molecules) becomes narrow so as to reduce the permeability rate of the moisture.

### SUMMARY OF THE INVENTION

In order to improve the problem encountered by the prior art, the present invention provides ultraviolet glue for sealing glass substrates in which the moisture permeability rate has been further reduced.

The ultraviolet curing glue used for sealing glass substrate comprises ultraviolet glue base, and inorganic solid particulates having diameter ranging from 0.1 to 0.3 micro meter and evenly mixed with the ultraviolet glue base to form the ultraviolet curing glue mixture, wherein the inorganic solid particulates is less than 40% of the volume of mixture of the curing glue.

Preferably, wherein the solid particulates are transparent material or semi-transparent material.

Preferably, wherein the inorganic solid particulates are glass.

Preferably, wherein the inorganic particulates is about 10˜40% of the volume of the ultraviolet curing glue mixture.

It is another objective of the present invention to provide a method to make the ultraviolet curing glue, and the method includes the steps of:

1) providing inorganic material and grinding the inorganic material to solid particulates; and

2) mixing the solid particulates with an ultraviolet curing glue base so as to create the ultraviolet curing glue mixture.

Preferably, wherein further including a process of defoaming in step 2) to remove all bubbles within the ultraviolet curing glue mixture.

Preferably, wherein the defoaming process is conducted by centrifugal force.

Preferably, wherein the particulates have a diameter ranging from 0.1˜0.3 micro meter after grinding in step 1).

Preferably, wherein the inorganic material is ground with a ball mill, and the inorganic material is glass.

Preferably, wherein in step 2), the solid particulates is about 10˜40% of the volume of the ultraviolet curing glue mixture.

Preferably, wherein in step 2), the solid particulates is about 25˜40% of the volume of the ultraviolet curing glue mixture.

The ultraviolet curing glue made in accordance with the present invention can readily reduce and slow down the moisture permeability rate thereby increasing the moisture blockage of the sealant and prolong the service life of the product. In addition, the method for making the ultraviolet curing glue is comparably simplified, and easy to manipulate.

### BRIEF DESCRIPTION OF DRAWINGS

FIG. 1 is an illustrational view showing the moisture permeability of the existing ultraviolet curing glue;

FIG. 2 is an illustrational view showing the moisture permeability of an ultraviolet curing glue made in accordance with the present invention; and

FIG. 3 is cross sectional view showing a pair of glass substrates are sealed with the ultraviolet curing glue made in accordance with the present invention.

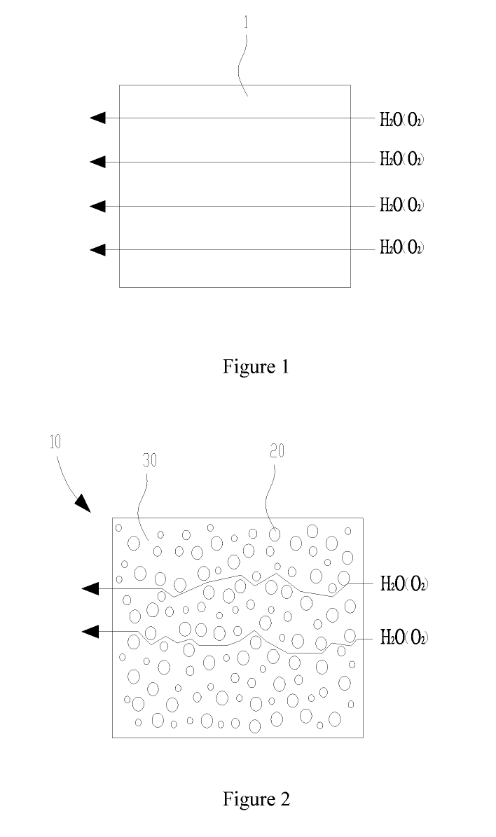

### DETAILED DESCRIPTION OF PREFERRED EMBODIMENT

Detailed description will be given to the preferred embodiments in view of the accompanied drawings.

### Example I.

In the preferred embodiment of the present invention, inorganic particulates are mixed with the ultraviolet curing glue base so as to further reduce and slow down the moisture permeability rate of the ultraviolet curing glue. The inorganic material used in the current embodiment is glass, and the method of making the ultraviolet curing glue made in accordance with the present invention includes the following steps.

1. Taking a glass material and then grinding it within a ball ill so as to have this inorganic material to become solid glass particulates having a diameter below 3 micro meters.

2) Mixing the glass solid particulates with the ultraviolet curing glue base evenly so as to create the ultraviolet curing glue mixture. The quantity of the inorganic particulates is about 40% of the mixture in volume. During the mixture, air bubbles may be trapped within the mixture, and those trapped bubbles are detrimental to the performance of the ultraviolet glue. Accordingly, a process of defoaming is needed so remove the bubbles.

3. Conducting a centrifugal process so as to remove the bubbles within the ultraviolet curing glue mixture. After the defoaming process, the ultraviolet curing glue mixture can be used in manufacturing process.

As shown in FIG. 2, the ultraviolet curing glue mixture 10 is evenly distributed with the solid particulates 20 which can effectively reduce and slow down the space between the molecules of the ultraviolet curing glue 30 after it is cured. In light of this, the traveling path of the moisture and oxygen within the cured ultraviolet curing glue is blocked. As a result, the traveling path for the moisture and oxygen to travel to reach inside of the device is extended. This brings up a better packaging effect, and the service life of the packaging device is prolonged.

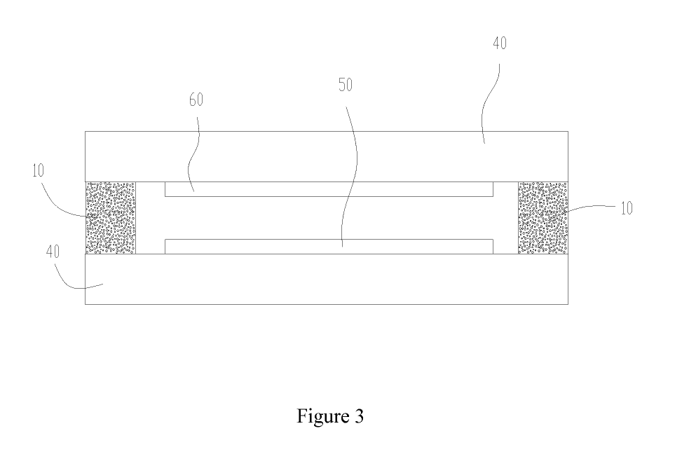

The application of the ultraviolet curing glue mixture can be readily demonstrate in FIG. 3. The ultraviolet curing glue mixture 10 is applied to borders of the glass substrates 40 so as to laminate those two glass substrates 40. The ultraviolet curing glue mixture 10 can readily seal those two glass substrates 40. Filling 50 is packaged between the glass substrates 40. Even the purpose of the present invention is to enhance the packaging performance, slowdown the permeability of both the moisture and oxygen into the internal of the glass substrates 40 thereby prolong the service life of the product. However, the permeability of the moisture and the oxygen is gradually progressed with time. Accordingly, it is still necessary to deploy desiccant 60 to absorb the moisture. Since the packaging process is generally identical to the existing process, and therefore no detailed description is given herebelow.

### Embodiment II.

In the current embodiment, quartz has been used as the solid particulates, and the method for making the ultraviolet curing glue for glass substrate includes the following steps.

1. Taking a quartz material and then grinding it within a ball ill so as to have this inorganic material to become solid glass particulates having a diameter below 0.1 micro meters.

2) Mixing the glass solid particulates with the ultraviolet curing glue base evenly so as to create the ultraviolet curing glue mixture. The quantity of the inorganic particulates is about 25% of the mixture in volume. During the mixture, air bubbles may be trapped within the mixture, and those trapped bubbles are detrimental to the performance of the ultraviolet glue. Accordingly, a process of defoaming is needed so remove the bubbles.

3. Conducting a centrifugal process so as to remove the bubbles within the ultraviolet curing glue mixture. After the defoaming process, the ultraviolet curing glue mixture can be used in manufacturing process.

The ultraviolet curing glue mixture made in accordance with the second embodiment has a very similar result as the result demonstrated by Embodiment I. On the other hand, this technology is generally used in the flat display panels, such as LCD and OLED. In order to properly laminated and packaged the glass substrates as well as not compromising the transparency of the laminated glass substrates, it is preferable to use transparent or semi-transparent inorganic material to serve as the solid particulates. Except those two embodiments illustrated above, other solid particulates having diameter other than 0.1˜3 micro meters have been tested. Even with 10% of of the solid particulates to the total volume of the mixture, the result is still acceptable.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. An ultraviolet curing glue used for sealing glass substrate, comprising ultraviolet glue base, and inorganic solid particulates having diameter ranging from 0.1 to 0.3 micro meter and evenly mixed with the ultraviolet glue base to form the ultraviolet curing glue mixture, wherein the inorganic solid particulates is less than 40% of the volume of mixture of the curing glue.

2. The ultraviolet curing glue used for sealing glass substrate as recited in claim 1, wherein the solid particulates are transparent material.

3. The ultraviolet curing glue used for sealing glass substrate as recited in claim 1, wherein the solid particulates are semi-transparent material.

4. The ultraviolet curing glue used for sealing glass substrate as recited in claim 2, wherein the inorganic solid particulates are glass.

5. The ultraviolet curing glue used for sealing glass substrate as recited in claim 1, wherein the inorganic particulates is about 10˜40% of the volume of the ultraviolet curing glue mixture.

6. The ultraviolet curing glue used for sealing glass substrate as recited in claim 2, wherein the inorganic particulates is about 10˜40% of the volume of the ultraviolet curing glue mixture.

7. The ultraviolet curing glue used for sealing glass substrate as recited in claim 3, wherein the inorganic particulates is about 10˜40% of the volume of the ultraviolet curing glue mixture.

8. A method for making ultraviolet curing glue, comprising the steps of:
1) providing inorganic material and grinding the inorganic material to solid particulates; and
2) mixing the solid particulates with an ultraviolet curing glue base so as to create the ultraviolet curing glue mixture.

9. The method for making ultraviolet curing glue as recited in claim 8, wherein further including a process of defoaming in step 2) to remove all bubbles within the ultraviolet curing glue mixture.

10. The method for making ultraviolet curing glue as recited in claim 9, wherein the defoaming process is conducted by centrifugal force.

11. The method for making ultraviolet curing glue as recited in claim 8, wherein the particulates have a diameter ranging from 0.1˜0.3 micro meter after grinding in step 1).

12. The method for making ultraviolet curing glue as recited in claim 9, wherein the particulates have a diameter ranging from 0.1˜0.3 micro meter after grinding in step 1).

13. The method for making ultraviolet curing glue as recited in claim 10, wherein the particulates have a diameter ranging from 0.1˜0.3 micro meter after grinding in step 1).

14. The method for making ultraviolet curing glue as recited in claim 8, wherein the inorganic material is ground with a ball mill, and the inorganic material is glass.

15. The method for making ultraviolet curing glue as recited in claim 8, wherein in step 2), the solid particulates is about 10˜40% of the volume of the ultraviolet curing glue mixture.

16. The method for making ultraviolet curing glue as recited in claim 9, wherein in step 2), the solid particulates is about 10˜40% of the volume of the ultraviolet curing glue mixture.

17. The method for making ultraviolet curing glue as recited in claim 10, wherein in step 2), the solid particulates is about 10˜40% of the volume of the ultraviolet curing glue mixture.

18. The method for making ultraviolet curing glue as recited in claim 8, wherein in step 2), the solid particulates is about 25˜40% of the volume of the ultraviolet curing glue mixture.
